(19) United States
(12) Patent Application Publication
(10) Pub. No.: US 2011/0109511 A1
(43) Pub. Date: May 12, 2011

(54) ANTENNA DEVICE

(75) Inventors: Andrey S. ANDRENKO, Kawasaki (JP); Takashi YAMAGA-JO, Kawasaki (JP)

(73) Assignee: FUJITSU LIMITED, Kawasaki-shi (JP)

(21) Appl. No.: 12/940,181

(22) Filed: Nov. 5, 2010

(30) Foreign Application Priority Data
Nov. 9, 2009 (JP) 2009-256373

(51) Int. Cl. H01Q 1/38

(52) U.S. Cl. 343/700 MS

(57) ABSTRACT

Provided is an antenna device, including: a substrate formed using a material having a high dielectric constant; and an antenna conductor accommodated inside the substrate, in which the antenna conductor includes: a first metal strip in a plate shape, in which a flat surface shape thereof has two opposing sides; and a plurality of second metal strips extending, from the two opposing sides of the first metal strip, toward one flat surface side of the first metal strip so as to be orthogonal to a flat surface of the first metal strip.

### CROSS-REFERENCE TO RELATED APPLICATION

This application is based upon and claims the benefit of priority of the prior Japanese Patent Application No. 2009-256373, filed on Nov. 9, 2009, the entire contents of which are incorporated herein by reference.

### FIELD

The present invention relates to an antenna device.

### BACKGROUND

The designs of radio communication devices have been becoming increasingly complicated year after year. The radio communication device is, for example, such an electronic equipment that has a radio communication function. Specific examples thereof may include a radio terminal, such as a mobile phone, a smartphone, a personal digital assistant (PDA), a personal computer (PC), and a global positioning system (GPS) terminal, and a radio communication application equipment, such as a radio communication card (for example, PCMCIA card).

Within an inside of the radio communication device, there is disposed an internal antenna that receives a radio wave. It is preferred that an antenna element of the internal antenna be made as small and light as possible. Further, the internal antenna satisfies design requirements for antenna gain and antenna efficiency, and some antennas are capable of handling different frequency bands so as to be able to support a wideband or multiple bands.

### RELATED ART DOCUMENTS

[Patent document 1] Japanese Laid-open Patent Publication No. 2007-89109
[Patent document 2] Japanese Laid-open Patent Publication No. 2002-190703
[Patent document 3] Japanese Laid-open Patent Publication No. 2004-194089 A

The conventional internal antenna of the radio communication device, such as an inverted-F antenna or a planar monopole antenna, occupies a large volume of the inside of the radio terminal in order to provide a wideband characteristic. In such circumstances, there has been a demand for downsizing of the internal antenna.

In addition, in a limited space of the inside of the radio communication device, a radio frequency circuit (RF circuit) mounted on a ground plane and the internal antenna are disposed in close proximity to each other. Accordingly, in order to perform efficient impedance matching between the RF circuit and the internal antenna, there is installed an LC circuit for an excitation port of the internal antenna. Such installation of the LC circuit poses a fear of causing a narrowed bandwidth and a declined antenna efficiency, in addition to hindering the downsizing of the internal antenna.

### SUMMARY

According to the one aspect of the present invention, there is provided an antenna device, including:

a substrate formed using a material having a high dielectric constant; and

an antenna conductor accommodated inside the substrate, wherein the antenna conductor includes:
a first metal strip in a plate shape, wherein a flat surface shape thereof has two opposing sides; and
a plurality of second metal strips extending, from the two opposing sides of the first metal strip, toward one flat surface side of the first metal strip so as to be orthogonal to a flat surface of the first metal strip.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A illustrates a configuration example of an antenna device according to an embodiment;

FIG. 1B is an explanatory diagram in which the antenna device illustrated in FIG. 1A is viewed from a side thereof;

FIG. 2 is a graph showing a voltage standing wave ratio (VSWR) of the antenna device illustrated in FIG. 1A;

FIG. 3A is an antenna circuit diagram in which an LC circuit is used as a comparative example;

FIG. 3B is an antenna circuit diagram in which the antenna device illustrated in FIG. 1A is used;

FIG. 4 illustrates a gain radiation pattern of the antenna device illustrated in FIG. 1A;

FIG. 5 illustrates a configuration example of an antenna device according to another embodiment;

FIG. 6 is a graph showing a VSWR of the antenna device illustrated in FIG. 5;

FIG. 7 illustrates a gain radiation pattern of the antenna device illustrated in FIG. 5; and

FIG. 8 illustrates an example of an antenna device applied to an electronic equipment having a wireless communication function.

### DESCRIPTION OF EMBODIMENTS

Hereinbelow, with reference to the drawings, description is given of embodiments of the present invention. Configurations of the embodiments described below are given as an example, and the present invention is not limited to the configurations of the embodiments.

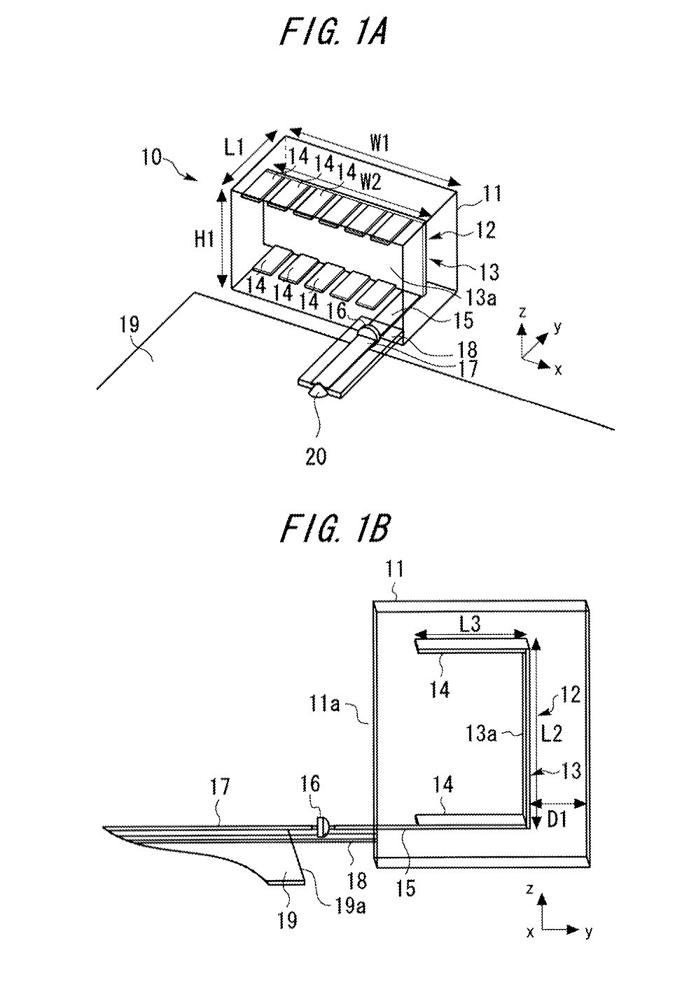

FIG. 1A illustrates a configuration example of an antenna device according to an embodiment, and FIG. 1B is an explanatory diagram illustrating a state of the antenna device illustrated in FIG. 1A viewed from a side thereof. FIGS. 1A and 1B illustrate an antenna device used for a radio communication device. The radio communication device is, for example, such an electronic equipment that has a radio communication function. Specific examples thereof may include a radio terminal, such as a mobile phone, a smartphone, a PDA, a PC, and a GPS terminal, and a radio communication application equipment, such as a radio communication card (for example, PCMCIA card).

An antenna device 10 is a ceramic chip antenna (ceramic chip monopole) for a handset that uses a 2-GHz band. The handset includes at least such a radio communication terminal as a mobile phone or a smartphone.

In FIGS. 1A and 1B, the antenna device 10 includes a substrate 11 and an antenna conductor 12 accommodated inside the substrate 11.

Here, the substrate 11 has a rectangular parallelepiped shape formed using a ceramic material, which is one example of a material that has a high dielectric constant. In the embodiment, a ceramic material having a dielectric constant of approximately 10 is used. Specifically, the substrate 11 is formed using a ceramic material having a dielectric constant ∈ᵣ of 10.2 and a dielectric dissipation factor tan δ of 0.0023. The dielectric constant of the substrate preferably satisfies ∈ᵣ=10±1.

The antenna conductor (antenna element) 12 includes a first metal strip 13 in a plate shape, in which a flat surface shape thereof is rectangular (rectangle in FIGS. 1A and 1B), and a plurality of second metal strips 14 each having a rectangular plate shape. Within an inside of the substrate 11, the first metal strip 13 is erected in a height direction of the substrate 11 (z-direction of FIGS. 1A and 1B) and is disposed in a width direction of the substrate 11 (x-direction of FIGS. 1A and 1B).

Each of the second metal strips 14 extends, from respective outer edges constituting two opposing sides in a width direction of the first metal strip 13, toward a flat surface 13a side, which is one flat surface of the first metal strip 13, so as to be perpendicular to the first metal strip 13. In the embodiment, the plurality of second metal strips 14 are strip-like plates that have the same shape and extend in a length direction of the substrate 11 (y-direction of FIGS. 1A and 1B), and each of the second metal strips 14 is provided with a space from an adjacent second metal strip 14.

For example, the antenna conductor 12 may be formed as follows. That is, in a plate having a plurality of extending portions that are to serve as the second metal strips, each of the extending portions is bent from two opposing sides of a rectangle so as to form a squared U-shape.

The antenna device 10 further includes a conductor plate 15 serving as a conductor, an inductor element 16, and a metal strip 17. The conductor plate 15 is connected to the antenna conductor 12. The conductor plate 15 is such a metal plate that extends in the same direction as the second metal strip 14 and is longer than the second metal strip 14. The conductor plate 15 may be formed by bending a strip portion extending from the first metal strip 13 at a right angle. As described above, the antenna conductor 12 has a three-dimensional shape.

When a portion of the conductor plate 15, which is connected to the first metal strip 13, is assumed to be a proximal end portion (one end portion), the inductor element 16 is connected to a distal end portion (the other end portion) of the conductor plate 15. The inductor element 16 is connected to one end portion of the metal strip 17 in a plate shape. The metal strip 17 is a feed plate that functions as a feed line.

The conductor plate 15, the inductor element 16, and the metal strip 17 are disposed on a supporting member in a plate shape, which extends from a front side 11a of the substrate 11 in a direction orthogonal to the front side 11a, and are linearly supported by the supporting member 18.

The antenna device 10 (antenna chip monopole) having such a configuration as described above is attached with a space from a ground plane 19 including a radio frequency circuit (RF circuit) (not shown). The ground plane 19 is, for example, a print wiring board (PWB). The ground plane 19 has a linear outer edge 19a. The antenna device 10 is attached to the ground plane 19 with a part of the supporting member 18 secured onto the ground plane 19 in such a manner that there is formed a space between the outer edge 19a and the front side 11a of the substrate 11.

In this case, the antenna device 10 is attached to the ground plane 19 such that the first metal strip 13 is perpendicular to the ground plane 19 and the plurality of second metal strips 14 are each horizontal to the ground plane 19. With this configuration, it is possible to reduce the volume occupied by the antenna device 10 within the handset.

In a state in which the antenna device 10 is attached to the ground plane 19, a distal end portion of the metal strip 13 is electrically connected to a feed port (not shown) provided to the ground plane 19. In FIG. 1, the distal end portion of the metal strip 13 is connected to the feed port by means of solder 20.

According to the antenna device 10 described above, owing to the antenna conductor 12 formed into the three-dimensional squared U-shape, the volume of the antenna conductor 12 may be reduced, which in turn results in a reduced volume of the substrate 11. In other words, downsizing of the antenna device 10 may be achieved.

Further, according to the antenna conductor 12, a large number of lines (squared U-shaped lines) may be drawn via the first metal strip 13 between the distal end of each of the second metal strips 14 and the distal end portion of the metal strip 17. This means that the antenna conductor 12 is capable of receiving a large number of wavelengths. Specifically, this means that a resonance frequency bandwidth receivable by the antenna may be adjusted using the width of the first metal strip 13 and the number of the second metal strips 14.

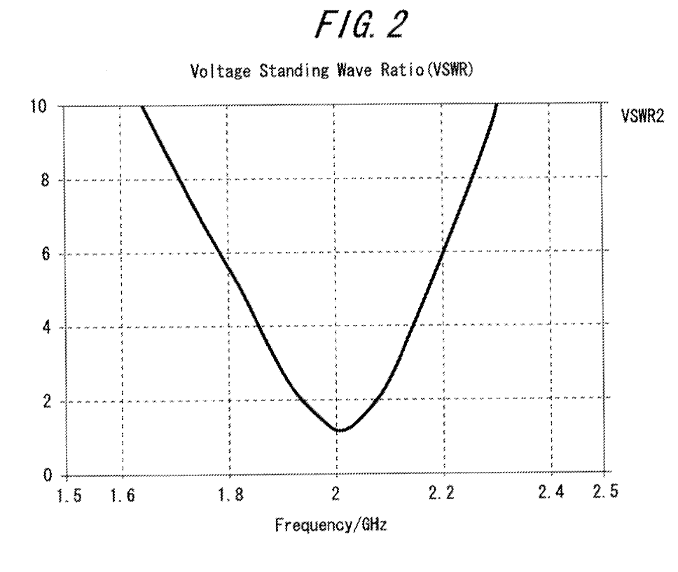

FIG. 2 is a graph showing a voltage standing wave ratio (VSWR) characteristic of the antenna device 10 illustrated in FIGS. 1A and 1B. As can be seen from FIG. 2, when the VSWR is 2, it is possible to cover a wideband ranging from approximately 1.9 GHz to approximately 2.1 GHz with the resonance frequency being 2 GHz. Hence, the antenna device 10 is adaptable to the wideband.

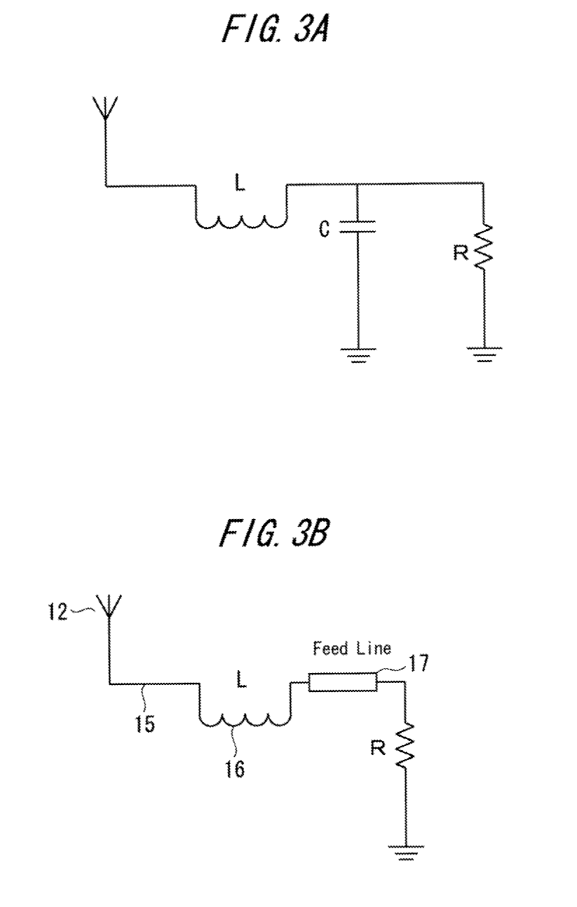

Further, the metal strip 17, which serves as the feed line, and the inductor element 16 function as an impedance matching circuit that performs impedance matching for the antenna. FIG. 3A is an antenna circuit diagram in which an LC circuit is used as a comparative example, and FIG. 3B is an antenna circuit diagram in which the antenna device 10 illustrated in FIG. 1 is used.

In the comparative example illustrated in FIG. 3A, in order to perform the impedance matching between the antenna and the RF circuit (illustrated as resistor R), the LC circuit is interposed between the antenna and the RF circuit. As the capacitor that constitutes the LC circuit, a capacitor having a large capacity is required, and hence the capacitor becomes a large factor responsible for increasing the volume of the antenna device.

On the other hand, according to the embodiment, as illustrated in FIG. 3B, the RF circuit (illustrated as resistor R) and the antenna (antenna conductor 12) are in a state of being connected in series by the inductor element 16 and the metal strip 17 (feed line). According to the embodiment, the feed line (metal strip 17) functions as a substitute for the capacitor of FIG. 3A, and hence it is possible to perform appropriate impedance matching between the antenna conductor 12 and the metal strip 17. The metal strip 17 is small in occupied volume, compared with the capacitor. As a result, the downsizing of the antenna device 10 may be achieved.

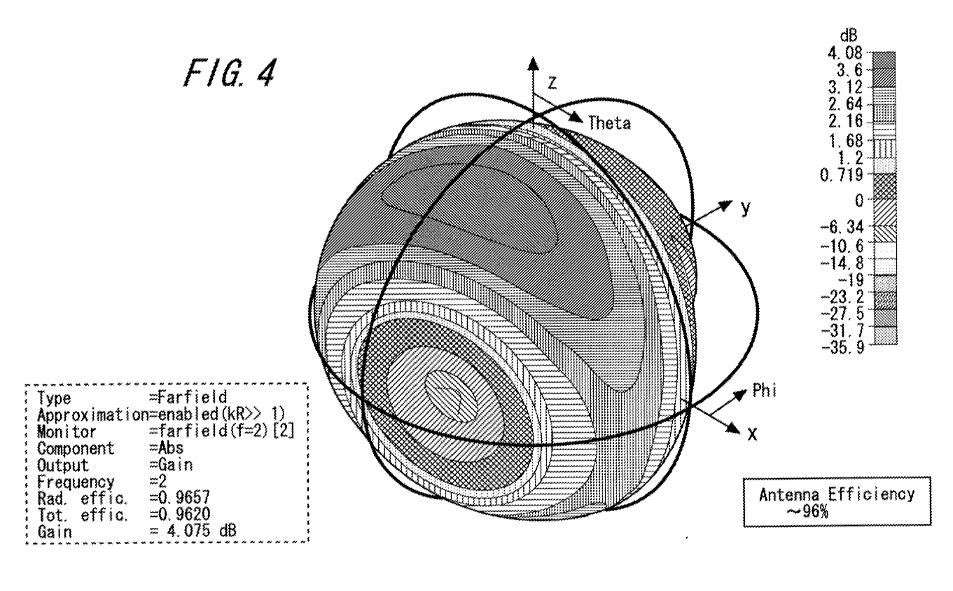

FIG. 4 shows results obtained by simulating a gain radiation pattern of the antenna device illustrated in FIGS. 1A and 1B according to the embodiment. As conditions, a length L1, a width W1, and a height H1 of the substrate 11 of the antenna device 10 illustrated in FIGS. 1A and 1B were set to 5 mm, 10 mm, and 6 mm, respectively. Further, the first metal strip 13 had dimensions of a width W2 of 9.25 mm by a length L2 of 4.2 mm. Further, each of the second metal strips 14 had dimensions of a length L3 of 2.6 mm by a width of 1 mm. A space between the second metal strips 14 was set to 0.5 mm. Further, the impedance of the RF circuit was set to 50Ω, and the inductance of the inductor element 16 was set to 6 n H. Under such conditions, the antenna device 10 was able to obtain an antenna efficiency of 96%.

As described above, according to the antenna device 10, suitable impedance matching may be performed while the downsizing of the antenna device 10 is achieved, and hence it is possible to obtain a ceramic chip antenna (ceramic chip monopole) having high efficiency in a wide bandwidth.

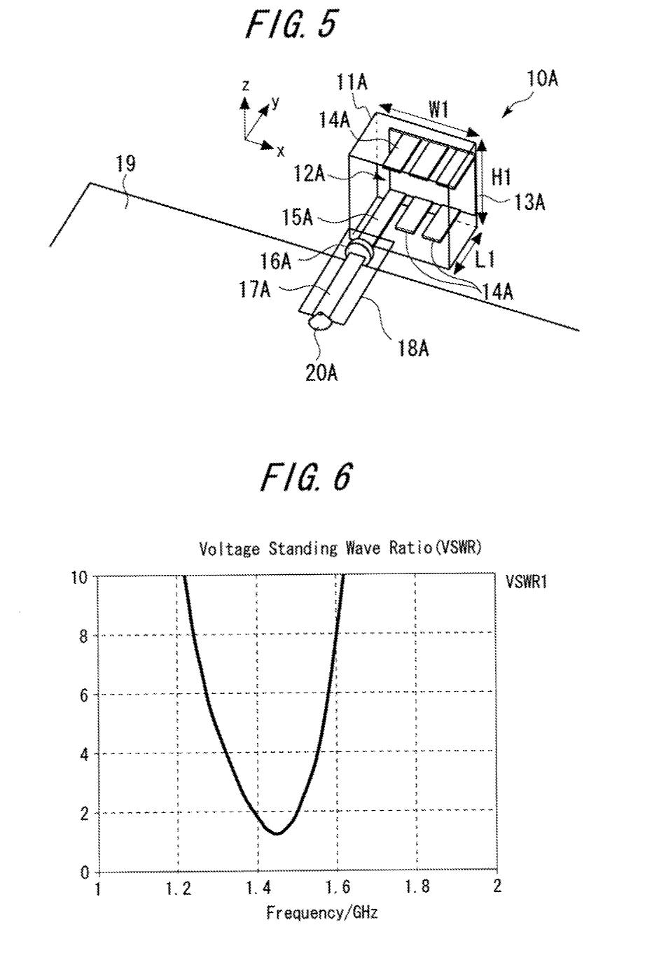

FIG. 5 illustrates a state in which an antenna device 10A according to another embodiment is attached to the ground plane 19. The antenna device 10A is a ceramic chip antenna (ceramic chip monopole) for a GPS application, and covers a GPS frequency band, which is a 1.5-GHz band.

The antenna device 10A includes a substrate 11A and an antenna conductor 12A. Similarly to the antenna conductor 12, the antenna conductor 12A includes a first metal strip 13A forming a squared U-shape with a plurality of metal strips 14A. Further, similarly to the antenna device 10, the antenna conductor 12A includes a conductor plate 15A, an inductor element 16A, and a metal strip 17A as a feed line, which are connected in series to each other. The conductor plate 15A, the inductor element 16A, and the metal strip 17A are disposed on a supporting member 18A extending from a front side of the substrate 11.

Then, a part of the supporting member 18A is secured onto the ground plane 19, and hence the substrate 11A having the antenna conductor 12A accommodated (embedded) is in a state of being disposed with a space from the ground plane 19. A distal end of the metal strip 17A is electrically connected, via a feed port by means of solder 20A, to an RF circuit for GPS (not shown) provided to the ground plane 19.

It should be noted that, in the second embodiment, in view of the fact that the used bandwidth, that is, 1.5 GHz, is narrower than 2 GHz, the width of the first metal strip 13A is shortened, and the number of the second metal strips 14A is smaller.

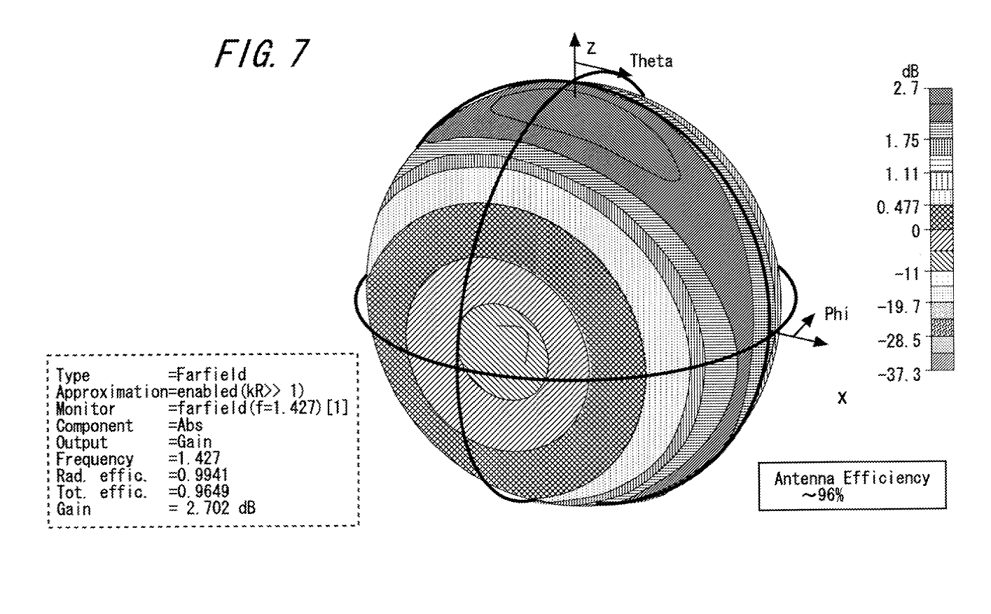

FIG. 6 is a graph showing a VSWR characteristic of the antenna device 10A, and FIG. 7 shows results obtained by simulating a gain radiation pattern of the antenna device 10A. As shown in FIG. 6, when the VSWR is 1, the antenna device 10A is able to cover 1.5 GHz. Further, as shown in FIG. 7, it is possible to obtain an antenna efficiency of 96%.

It should be noted that, as conditions for the simulation, a length L1, a width W1, and a height H1 of the substrate 11A were set to 3.5 mm, 4.75 mm, and 4 mm, respectively, the dielectric constant of the substrate HA was set to 10, and the inductance of the inductor element 16A was set to 20 n H. Further, the metal strip 13A was set as a rectangular plate of 4.75 mm (x-direction)×4.2 mm (y-direction). Further, each of the metal strips 14A was a rectangular plate of 1 mm (x-direction)×2.5 mm (y-direction), and a space between the metal strips 14A was set to 0.5 mm.

If the above-mentioned antenna device 10 and antenna device 10A are provided within the same radio communication device, such a radio communication device becomes capable of supporting both the 2-GHz band and the 1.5-GHz band, that is, multiple bands. It should be noted that, though illustrated in different drawing sheets, the antenna device 10 and the antenna device 10A may be provided on the same ground plane 19.

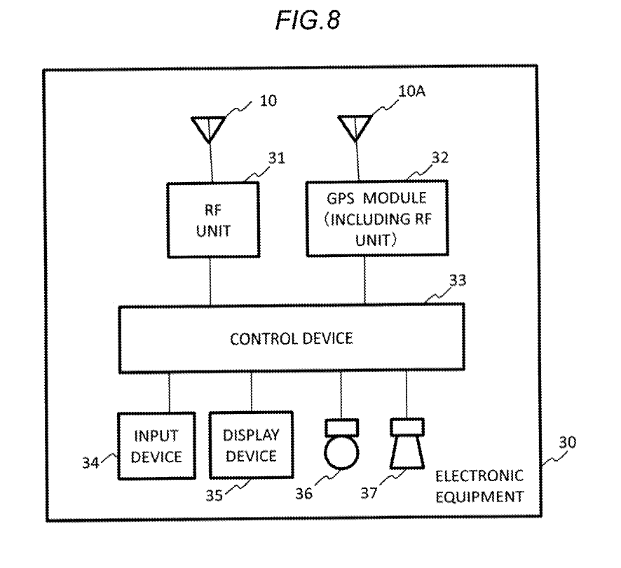

FIG. 8 is a diagram schematically illustrating one example of an electronic equipment (radio communication device) with a radio communication function, which includes the antenna device 10 and the antenna device 10A. In FIG. 8, an electronic equipment 30 is a mobile phone having a GPS function.

The electronic equipment 30 includes the antenna device and the antenna device 10A. Further, the electronic equipment 30 includes an RF section 31 connected to the antenna device 10, a GPS module 32 connected to the antenna device 10A, and a control device 33 connected to the RF section 31 and the GPS module 32. The control device 33 is connected to an input device 34 including a key and a button, a display device 35 such as a liquid crystal display, a microphone 36, and a speaker 37. The RF section 31 and the GPS module 32 each function as a radio communication section.

The RF section 31 includes an RF section including an RF circuit and a baseband processing section. A radio signal in the 2-GHz band, which is received by the antenna device 10, is subjected to down-conversion and A/D conversion by the RF circuit, and is then demodulated into a baseband signal by the baseband processing section. The baseband signal is input to the control device 33.

The control device 33 includes a communication processor, an application processor, various kinds of storage devices, device drivers for the input device 34 and the display device 35, analog front ends (processing circuits for analog audio signals) for the microphone 36 and the speaker 37, and the like.

In the control device 33, for example, in a case where the baseband signal is input from the RF section 31, the communication processor performs processing of extracting coded data from the baseband signal to decode the data, and error-correcting processing with respect to the data, for example. If the data is audio data, for example, the communication processor connects the audio data to the analog front end, in which audio corresponding to the audio data is reproduced, and then, the audio is output from the speaker 27.

On the other hand, when an analog audio signal is input from the microphone 36, a coded signal of a digital audio signal is generated by the analog front end and the communication processor, and is then modulated into a baseband signal by the baseband processing section of the RF section 31. After the baseband signal is subjected to D/A conversion and up-conversion into a radio signal by the RF circuit, the radio signal is emitted from the antenna device 10.

It should be noted that, if data obtained by the communication processor is non-audio data, for example, the application processor performs predetermined processing with respect to the non-audio data. For example, the application processor controls the display device 35 to display characters and graphics based on the non-audio data on the display device 35.

Further, a radio signal in the 1.5-GHz band, which is received by the antenna device 10A, is input to the GPS module 32. The GPS module 32 includes an RF circuit and a GPS baseband processing section. The RF circuit performs the down-conversion and the A/D conversion on the radio signal. The baseband section performs demodulation processing with respect to a digital signal from the RF circuit, and decoding processing on GPS data (for example, C/A code and navigation data of a GPS satellite) contained in the demodulated signal. The decoded GPS data is input to the control device 33, and then, predetermined processing is performed, such as control with respect to the display device 35 for displaying a current position of the electronic equipment 30. Operation of the electronic equipment 30 is performed through button or key operation using the input device 34.

According to the embodiments described above, suitable impedance matching may be performed while the downsizing of the radio communication device is achieved. In addition, a wideband or multiple bands may be supported.

It should be noted that, in the embodiments, strip-like metal plates having a thickness of 0.25 mm was used as the metal strips 17 and 17A. The thicknesses, widths, and lengths of the metal strips 17 and 17A may be changed as appropriate. Further, apart from the above, the dimensions of the antenna devices 10 and 10A, and the dielectric constant of the substrate have been given as an example, and thus may be changed as appropriate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An antenna device, comprising:
a substrate formed using a material having a high dielectric constant; and
an antenna conductor accommodated inside the substrate, wherein the antenna conductor includes:
a first metal strip in a plate shape, in which a flat surface shape thereof has two opposing sides; and
a plurality of second metal strips extending, from the two opposing sides of the first metal strip, toward one flat surface side of the first metal strip so as to be orthogonal to a flat surface of the first metal strip.

2. The antenna device according to claim 1, further comprising:
an inductor element; and
a metal strip that serves as a substitute for a capacitor element,
the inductor element and the metal strip being connected in series to the antenna conductor via a conductor.

3. The antenna device according to claim 2, wherein:
an end portion of the metal strip, which is opposite to an end portion connected to the inductor element, is connected to a radio frequency circuit provided to a ground plane; and
the inductor element and the metal strip function as an impedance matching circuit between the antenna conductor and the radio frequency circuit.

4. The antenna device according to claim 3, wherein:
the conductor, the inductor element, and the metal strip are disposed in line;
an end portion of the conductor, which is opposite to an end portion connected to the inductor element, is connected to one of the two opposing sides of the first metal strip so as to be orthogonal to the flat surface of the first metal strip;
an end portion of the metal strip, which is opposite to an end portion connected to the inductor element, is attached to the ground plane; and
the substrate accommodating the antenna conductor is supported by a supporting member that supports the metal strip, the inductor element, and the conductor, at a position spaced apart from an outer edge of the ground plane.

5. The antenna device according to claim 4, wherein:
the first metal strip is disposed perpendicularly to the ground plane; and
the plurality of second metal strips are disposed horizontally to the ground plane.

6. An electronic equipment with a radio communication function, comprising:
an antenna device; and
a radio communication section that performs radio communication via the antenna device, wherein:
the antenna device includes:
a substrate formed using a material having a high dielectric constant; and
an antenna conductor accommodated inside the substrate; and
the antenna conductor comprises:
a first metal strip in a plate shape, in which a flat surface shape thereof has two opposing sides; and
a plurality of second metal strips extending, from the two opposing sides of the first metal strip, toward one flat surface side of the first metal strip so as to be orthogonal to a flat surface of the first metal strip.
